(19) United States
(12) Patent Application Publication
(10) Pub. No.: US 2010/0266836 A1
(43) Pub. Date: Oct. 21, 2010

(54) MESOSTRUCTURED SKINS FOR APPLICATION IN THE AERONAUTICS AND AEROSPACE INDUSTRIES

(75) Inventors: Elisa Campazzi, Boulogne Billancourt (FR); Emmanuelle Lancelle-Beltran, Bagneux (FR); Clement Sanchez, Bures Sur Yvette (FR)

Correspondence Address: OBLON, SPIVAK, MCCLELLAND MAIER & NEUSTADT, L.L.P., 1940 DUKE STREET, ALEXANDRIA, VA, 22314, US

(73) Assignees: EURO. AERONAUTIC DEFENCE AND SPACE CO. EADS FRANCE, Paris (FR); UNIVERSITE PARIS 6 PIERRE ET MARIE CURIE, Paris cedex 05 (FR); CENTRE NATIONAL DE LA RECHERCHE SCIENTIFIQUE (CNRS), Paris (FR)

(21) Appl. No.: 12/443,869

(22) PCT Filed: Sep. 21, 2007
(86) PCT No.: PCT/FR07/51985

§ 371 Date: Jun. 28, 2010

(30) Foreign Application Priority Data
Oct. 2, 2006 (FR) 0608614

(51) Int. Cl. B32B 5/14; B32B 15/04; B05D 3/06; B05D 3/10; B05D 3/02

(52) U.S. Cl. 428/310.5; 428/469; 428/470; 428/450; 428/447; 427/558; 427/343; 427/344; 427/397.7

(57) ABSTRACT

The present invention relates to a structure comprising:
at least one mesostructured layer prepared by the sol-gel route from at least one specific molecular metallic precursor in the presence of an amphiphilic surfactant, and
a metal substrate.

It also relates to its process of preparation and to its use in the aeronautical or aerospace field.

The present invention relates to a structure comprising a mesostructured coating intended to be used in aeronautical and aerospace applications.

In the aeronautical field, protection against corrosion is generally provided by surface treatments based on chromium(VI), for example by means of a chromic anodic oxidation process, or a conversion layer.

However, it has been found that chromium(VI) is toxic, carcinogenic and dangerous to the environment. Its use should be banned in the long run.

There thus exists a need to find another system providing protection, for example against corrosion but also against scratches or rubbing actions or others, which is at least as effective as those existing.

Organic/inorganic hybrid materials prepared by the sol-gel route have already been envisaged in the art.

For example, the document US 2003/024432 describes a coating having corrosion-resistant properties prepared by the sol-gel route from an organometallic salt, such as an alkoxyzirconium, from an organosilane and from one or more compounds carrying a borate, zinc or phosphate functional group, in the presence of an organic catalyst, such as acetic acid.

The documents U.S. Pat. No. 6,261,638 and EP 1 097 259 for their part describe processes for preventing the corrosion of metals comprising the application of a treatment solution based on polyfunctional silanes and on difunctional silanes comprising, in their chain, several sulfur atoms, respectively.

However, these materials exhibit the disadvantage of not being micro- or nanostructured, that is to say that the distribution of the organic and inorganic domains in the material cannot be controlled at the micrometric or nanometric scale. This random distribution can result in properties which are not reproducible from one material to another.

One advantage of the sol-gel process consists in constructing a three-dimensional network from starting precursors under “mild” conditions, that is to say at a temperature of less than 200° C., and in an aqueous or aqueous/solvent medium which is less toxic to the environment than those used for conventional surface treatments.

The starting precursors generally used in said sol-gel process are metal alkoxides comprising one or more hydrolyzable groups.

Other types of “mesostructured” coatings having corrosion-resistant properties have recently been described in the paper “TiOx self-assembled networks prepared by templating approach as nanostructured reservoirs for self-healing anticorrosion pre-treatments” by S. V. Lamaka et al., Electrochemistry Communications, 8, 2006, 421-428.

However, these coatings are prepared from a titanium alkoxide, resulting in a photocatalyzing material which rapidly deteriorates when it is exposed to the sun.

The Applicant has discovered, surprisingly, that control at the nanometric scale of the nature of the organic/inorganic interfaces with certain materials makes it possible to achieve better performances in terms of macroscopic properties, such as resistance to corrosion, resistance to scratches and to rubbing actions, mechanical strength, thickness and quality of the film, density, coloration and hydrophobic nature adjustable as desired, and in terms of repeatability.

This control is achieved by virtue of structures comprising at least one specific mesostructured layer and a metal substrate.

Hybrid and inorganic mesostructured layers are in particular known and described in the paper “Mesostructured hybrid organic-inorganic thin films” by L. Nicole et al., J. Mater. Chem., 2005, 15, 3598-3627.

These mesostructured layers exhibit a controlled porosity, that is to say a pore size of between 2 and 50 nm, measured, for example, according to the Brunauer, Emmett and Teller (BET) method, and are structured at the nanometric scale.

They are obtained from sol-gel precursors and surface-active molecules. This particular combination makes possible the construction of an inorganic or hybrid network around the surface-active molecules. A mesostructured material is then obtained, the micelles of surface-active molecules being arranged periodically throughout the material.

These mesostructured layers can comprise diverse functionalities which make it possible to confer on a metal substrate (or surface), in particular an aluminum, titanium or magnesium alloy, or a steel, for example, protection against corrosion, resistance to scratches and to rubbing actions, good mechanical strength and/or a coloring, and/or constitute a probe for quality control, while exhibiting good adhesion to the metal substrate.

In addition, these layers can make possible the coexistence of several different functionalities and can be deposited by any conventional technique, such as, for example, by dip coating, deposition on a rotating substrate (or spin coating), sprinkling, spraying, laminar flow coating and deposition with a brush. The individual components can be designed so as to have a lifetime compatible with industrial cycles, for example of greater than or equal to 12 months, and can be mixed immediately before their application. Their formulation exhibits the additional advantage of using components which are compatible with environmental regulations and in particular of being predominantly as an aqueous medium.

A subject matter of the present invention is thus a structure comprising:
at least one mesostructured layer prepared by the sol-gel route from at least one molecular metallic precursor of metal alkoxide or halide type of formula:

MZₙ (1),

R′ₓMZₙ₋ₓ (2)

L^{m}ₓMZₙ₋ₘₓ (3) or

(RO)ₙ₋₁M-R″-M(OR)ₙ₋₁ (4)

in which formulae (1) , (2) , (3) and (4):

M represents Al(III), Ce(III), Ce(IV), Zr(IV), Sn(IV), Nb(V), V(V), Ta(V) or Hf(V), preferably Al(III), Ce(III), Ce(IV), Zr(IV) or Nb(V), or a rare earth metal, such as Y(III), La(III) and Eu(III), the figure in brackets being the valency of the atom M;

n represents the valency of the atom M;

x is an integer ranging from 1 to n-1;

each Z represents, independently of one another, a halogen atom, such as F, Cl, Br and I, preferably Cl and Br, or an —OR group;

R represents an alkyl group preferably comprising from 1 to 4 carbon atoms, such as a methyl, ethyl, n-propyl, isopropyl, n-butyl, s-butyl or t-butyl group, preferably methyl or ethyl, better still ethyl;

each R′ represents, independently of one another, a nonhydrolyzable group chosen from alkyl groups, in particular C₁₋₄ alkyl groups, for example methyl, ethyl, propyl or butyl; alkenyl groups, in particular C₂₋₄ alkenyl groups, such as vinyl, 1-propenyl, 2-propenyl and butenyl; alkynyl groups, in particular C₂₋₄ alkynyl groups, such as acetylenyl and propargyl; aryl groups, in particular C₆₋₁₀ aryl groups, such as phenyl and naphthyl; methacryloyl or methacryloyloxy(C₁₋₁₀ alkyl) groups, such as methacryloyloxypropyl; epoxyalkyl or epoxyalkoxyalkyl groups in which the alkyl group is a linear, branched or cyclic C₁₋₁₀ alkyl group and the alkoxy group comprises from 1 to 10 carbon atoms, such as glycidyl and glycidyloxy(C₁₋₁₀ alkyl); C₂₋₁₀ haloalkyl groups, such as 3-chloropropyl; C₂₋₁₀ perhaloalkyl groups, such as perfluoropropyl; C₂₋₁₀ mercaptoalkyl groups, such as mercaptopropyl; C₂₋₁₀ aminoalkyl groups, such as 3-aminopropyl; (C₂₋₁₀ aminoalkyl)amino(C₂₋₁₀ alkyl) groups, such as 3-[(2-aminoethyl)amino]propyl; di(C₂₋₁₀ alkylene)triamino(C₂₋₁₀ alkyl) groups, such as 3-[diethylenetriamino]propyl, and imidazolyl(C₂₋₁₀ alkyl) groups;

L represents a monodentate or polydentate, preferably polydentate, complexing ligand, for example a carboxylic acid, such as acetic acid, a β-diketone, such as acetylacetone, a β-ketoester, such as methyl acetoacetate, an α- or β-hydroxy acid, such as lactic acid, an amino acid, such as alanine, a polyamine, such as diethylenetriamine (or DETA), or phosphonic acid or a phosphonate;

m represents the hydroxylation number of the ligand L; and

R″ represents a nonhydrolyzable functional group chosen from alkylene groups, preferably C₁₋₁₂ alkylene groups, for example methylene, ethylene, propylene, butylene, hexylene, octylene, decylene and dodecylene; N,N-di(C₂₋₁₀ alkylene)amino groups, such as N,N-diethyleneamino; bis[N,N-di(C₂₋₁₀ alkylene)amino] groups, such as bis[N-(3-propylene)-N-methyleneamino]; C₂₋₁₀ mercaptoalkylene groups, such as mercaptopropylene; (C₂₋₁₀ alkylene)polysulfide groups, such as propylenedisulfide or propylenetetrasulfide; alkenylene groups, in particular C₂₋₄ alkenylene groups, such as vinylene; arylene groups, in particular C₆₋₁₀ arylene groups, such as phenylene; di(C₂₋₁₀ alkylene)(C₆₋₁₀ arylene) groups, such as di(ethylene)phenylene; and N,N′-di(C₂₋₁₀ alkylene)ureido groups, such as N,N′-dipropyleneureido;

in the presence of at least one amphiphilic surfactant, and
a metal substrate.

A specific embodiment of the present invention is that, during the preparation of the mesostructured layer by the sol-gel route, the metallic molecular precursor or precursors of general formula (1), (2), (3) or (4) are used in combination with at least one silicon-based precursor of silicon alkoxide, organoalkoxysilane or silicon halide type.

Preferably, this or these silicon-based precursor or precursors of silicon alkoxide, organoalkoxysilane or silicon halide type correspond to the following formulae:

SiZ₄ (5)

R′ₓSiZ₄₋ₓ (6)

L^{m}ₓSiZ₄₋ₘₓ (7) or

(RO)₃Si—R″—Si(OR)₃ (8)

in which formulae (5), (6), (7) and (8) Z, R′, x, L, m and R″ have the same meanings as those indicated above.

Mention may in particular be made, as examples of organoalkoxysilane of formula (6), of 3-aminopropyl-trialkoxysilane (RO)₃Si—(CH₂)₃—NH₂, 3-(2-aminoethyl)-aminopropyltrialkoxysilane (RO)₃Si—(CH₂)₃—NH—(CH₂)₂—NH₂, 3-(trialkoxysilyl)propyldiethylenetriamine (RO)₃Si—(CH₂)₃—NH—(CH₂)₂—NH—(CH₂)₂—NH₂; 3-chloropropyl-trialkoxysilane (RO)₃Si—(CH₂)₃Cl, 3-mercaptopropyltrialkoxysilane (RO)₃Si—(CH₂)₃SH; or organosilylazoles of N-(3-trialkoxysilylpropyl)-4,5-dihydroimidazole type, R having the same meaning as above.

Use is preferably made, as examples of bisalkoxysilane of formula (8), of a bis[trialkoxysilyl]methane (RO)₃Si—CH₂—Si(OR)₃, a bis[trialkoxysilyl]ethane (RO)₃Si—(CH₂)₂—Si(OR)₃, a bis[trialkoxysilyl]octane (RO)₃Si—(CH₂)₈—Si(OR)₃, a bis[trialkoxysilylpropyl]amine (RO)₃Si—(CH₂)₃—NH—(CH₂)₃—Si(OR)₃, a bis[trialkoxysilylpropyl]ethylene-diamine (RO)₃Si—(CH₂)₃—NH—(CH₂)₂—NH—(CH₂)₃—Si(OR)₃, a bis[trialkoxysilylpropyl]disulfide (RO)₃Si—(CH₂)₃—S₂—(CH₂)₃—Si(OR)₃, a bis[trialkoxysilylpropyl]tetrasulfide (RO)₃Si—(CH₂)₃—S₄—(CH₂)₃—Si(OR)₃, a bis-[trialkoxysilylpropyl]urea (RO)₃Si—(CH₂)₃—NH—CO—NH—(CH₂)₃—Si(OR)₃ or a bis[trialkoxysilylethyl]phenyl (RO)₃Si—(CH₂)₂—C₆H₄—(CH₂)₂—Si(OR)₃, R having the same meaning as above.

The structure can additionally comprise another ingredient, such as a particulate precursor of oxide or hydroxide type, such as cerium oxide or zirconium oxide.

The amphiphilic surfactant(s) which can be used in the invention are ionic, such as anionic or cationic, amphoteric, zwitterionic or nonionic amphiphilic surfactants which can in addition be photopolymerizable or heat polymerizable. This surfactant can be an amphiphilic molecule or a macromolecule (or polymer) exhibiting an amphiphilic structure.

The anionic surfactants preferably used in the present invention are anionic amphiphilic molecules, such as phosphates, for example C₁₂H₂₅OPO₃H₂, sulfates, for example CₚH₂ₚ₊₁OSO₃Na, with p=12, 14, 16 or 18, sulfonates, for example C₁₆H₃₃SO₃H and C₁₂H₂₅C₆H₄SO₃Na, and carboxylic acids, for example stearic acid C₁₇H₃₅CO₂H.

Mention may in particular be made, as examples of cationic amphiphilic surfactant, of quaternary ammonium salts or of phosphonium salts.

Specific quaternary ammonium salts are chosen in particular from those corresponding to the following general formula (I):

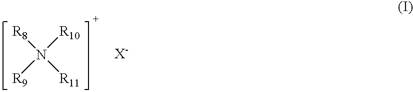

in which the R₈ to R₁₁ radicals, which can be identical or different, represent a linear or branched alkyl group comprising from 1 to 30 carbon atoms, and

X represents a halogen atom, such as a chlorine or bromine atom, or a sulfate.

Mention may in particular be made, among quaternary ammonium salts of formula (I), of tetraalkylammonium halides, such as, for example, dialkyldimethylammonium or alkyltrimethylammonium halides, in which the alkyl radical comprises approximately from 12 to 22 carbon atoms, in particular behenyltrimethylammonium, distearyldimethylammonium, cetyltrimethylammonium or benzyldimethylstearylammonium halides. The preferred halides are chlorides and bromides.

Mention may in particular be made, as examples of amphoteric or zwitterionic amphiphilic surfactant, of amino acids, such as aminopropionic acids of formula (R₁₂)₃N⁺—CH₂—CH₂—COO⁻ in which each R₁₂, which are identical or different, represents a hydrogen atom or a C₁₋₂₀ alkyl group, such as dodecyl, and more particularly dodecylaminopropionic acid.

The molecular nonionic amphiphilic surfactants which can be used in the present invention are preferably ethoxylated linear C₁₂₋₂₂ alcohols comprising from 2 to 30 ethylene oxide units or esters of fatty acids comprising from 12 to 22 carbon atoms and of sorbitan. Mention may in particular be made, as examples, of those sold under the trade names Brij®, Span® and Tween® by Aldrich, for example Brij® 56 and 78, Tween® 20 and Span® 80.

The polymeric nonionic amphiphilic surfactants are any amphiphilic polymer having both a hydrophilic nature and a hydrophobic nature. Mention may in particular be made, as examples of such copolymers, of:
fluorinated copolymers CH₃—[CH₂—CH₂—CH₂—CH₂—O]ₙ—CO—R₁ with R₁═C₄F₉ or C₈F₁₇,
biological copolymers, such as polyamino acids, for example a polylysine, and alginates,
dendrimers, such as those described in G. J. A. A. Soler-Illia, L. Rozes, M. K. Boggiano, C. Sanchez, C. O. Turrin, A. M. Caminade and J. P. Majoral, Angew. Chem. Int. Ed., 2000, 39, No. 23, 4250-4254, for example (S═)P[O—C₆H₄—CH═N—N(CH₃)—P(═S)—[O—C₆H₄—CH═CH—C(═O)—OH]₂]₃,
block copolymers comprising two blocks, three blocks of A-B-A or A-B-C type or four blocks, and
any other copolymer with an amphiphilic nature known to a person skilled in the art, more particularly those described in S. Förster and M. Antonietti, Adv. Mater., 1998, 10, 195-217, or S. Förster and T. Plantenberg, Angew. Chem. Int. Ed., 2002, 41, 688-714, or H. Cölfen, Macromol. Rapid Commun., 2001, 22, 219-252.

Use is preferably made, in the context of the present invention, of an amphiphilic block copolymer of type:
copolymer based on poly((meth)acrylic acid),
copolymer based on polydiene,
copolymer based on hydrogenated diene,
copolymer based on poly(propylene oxide),
copolymers based on poly(ethylene oxide),
copolymer based on polyisobutylene,
copolymer based on polystyrene,
copolymer based on polysiloxane,
copolymer based on poly(2-vinylnaphthalene),
copolymer based on poly(vinylpyridine and N-methylvinylpyridinium iodide),
copolymer based on poly(vinylpyrrolidone).

Use is preferably made of a block copolymer composed of poly(alkylene oxide) chains, each block being composed of a poly(alkylene oxide) chain, the alkylene comprising a different number of carbon atoms according to each chain.

For example, for a two-block copolymer, one of the two blocks is composed of a poly(alkylene oxide) chain of hydrophilic nature and the other block is composed of a poly(alkylene oxide) chain of hydrophobic nature. For a three-block copolymer, two of the blocks are hydrophilic in nature while the other block, situated between the two hydrophilic blocks, is hydrophobic in nature. Preferably, in the case of a three-block copolymer, the poly(alkylene oxide) chains of hydrophilic nature are poly(ethylene oxide) chains, recorded as (PEO)ᵤ and (PEO)_{w}, and the poly(alkylene oxide) chains of hydrophobic nature are poly(propylene oxide) chains, recorded as (PPO)ᵥ, or poly(butylene oxide) chains, or else mixed chains in which each chain is a mixture of several alkylene oxide monomers. In the case of a three-block copolymer, use may be made of a compound of formula (PEO)ᵤ-(PPO)ᵥ-(PEO)_{w} with 5<u<106, 33<v<70 and 5<w<106. By way of example, use is made of Pluronic® P123 (u=w=20 and v=70) or else of Pluronic® F127 (u=w=106 and v=70), these products being sold by BASF or Aldrich.

The amphiphilic surfactant or surfactants are preferably used in an amount ranging from 0.05 to 2 mol %, and more particularly from 0.2 to 1 mol %, with respect to the total number of moles of the molecular metallic precursor or precursors. The total number of moles of the molecular metallic precursor or precursors comprises the total number of moles of the molecular metallic precursor or precursors of formulae (1) to (4) and of the possible silicon-based precursor.

A latex can additionally be added during the preparation of the mesostructured layer.

The mesostructured layer is functionalized, that is to say that it comprises groups which confer macroscopic properties on the substrate, such as resistance to corrosion, resistance to scratches and to rubbing actions, mechanical strength and hydrophobic nature which can be adjusted as desired, and/or groups constituting a probe for quality control.

The term “probe” is understood to mean, by way of example, an optical probe, a pH-sensitive probe, a dye or a fluorescent probe selective for specific cations or anions.

This functionalization results either from the presence, in at least one starting molecular metallic precursor of formula (2), (3), (4), (6), (7) or (8), of a group R′, L and/or R″ representing a group which confers a functionality (or group which confers a functional group on the mesostructured layer), or from the addition of at least one functionalizing agent during the preparation of the mesostructured layer or from the treatment of the mesostructured layer, after it has been produced, with at least one functionalizing agent, or also from a combination of these three possibilities.

The term “functionalizing agent” is understood to mean, within the meaning of the present invention, an agent which confers a function on the mesostructured layer, such as resistance to corrosion, resistance to scratches and rubbing actions or mechanical strength, or which forms a fluorescent probe for capturing halogenated compounds or a pH-sensitive probe, or which confers a coloration.

Mention may in particular be made, as examples of agent conferring resistance to corrosion, of organic anticorrosion agents of azole type, such as benzotriazole, tolyltriazole and imidazole, of amine type, such as aminopiperidine or aminopiperazine, of —SH mercaptan type, of —COO⁻ carboxylate type, such as acetate, or of phosphonate type, and inorganic anticorrosion agents of nonoxidizing ion type, such as molybdates, phosphates and borates.

Use may be made, as agent which confers resistance to scratches and rubbing actions, of a titanium or aluminum alkoxide, or silica or alumina nanoparticles.

Mention may in particular be made, as an example of an agent conferring mechanical strength, of zirconium oxide.

The agent constituting a fluorescent probe for capturing halogenated compounds can be composed of an anthracene molecule carrying imidazolium groups.

Use may preferably be made, as agent constituting a pH-sensitive probe, of methyl orange or phenolphthalein.

Mention may in particular be made, as examples of agent conferring a coloration, of rhodamine, fluorescein, quinizarin, methylene blue and ethyl violet.

In a preferred embodiment of the invention, the starting components are added in the following order during the preparation of the mesostructured layer:
(1) the molecular metallic precursor or precursors of formula (1), (2), (3) or (4), as defined above,
(2) optionally the silicon alkoxide(s) or halide(s) of formula (5), (6), (7) or (8), as defined above,
(3) the amphiphilic surfactant or surfactants,
(4) an aqueous or water/alcohol, preferably water/ethanol, medium, and
(5) optionally the functionalizing agent or agents and optionally a latex.

The structure can comprise several mesostructured layers, for example from 2 to 10 layers, the porosities of which constitute a gradient, that is to say, for example in the case of four mesostructured layers exhibiting respective porosities P1, P2, P3 and P4 of between 2 and 50 nm, P1>P2>P3>P4, the layer exhibiting a porosity P1 being in direct contact with the substrate.

Another embodiment is that the structure comprises a porosity gradient in one and the same mesostructured layer.

The metal substrate which can be used in the present invention is preferably made of titanium, of aluminum or one of their respective alloys, such as, for example, titanium TA6V, aluminum from the 2000 family, more particularly Al 2024, which may or may not be plated, aluminum from the 7000 family, more particularly Al 7075 or 7175, and aluminum from the 6000 or 5000 family, or of stainless steel, such as, for example, 35 NCD 16 or 15-5 PH, or of magnesium alloy.

The mesostructured layer is deposited on metal substrates using techniques which are simple to employ, for example by dip coating, deposition on a rotating substrate (or spin coating), sprinkling, spraying, laminar flow coating or deposition with a brush, and preferably by spraying. In addition, these techniques use products which are compatible with the environment.

The structures thus obtained exhibit in particular resistance to corrosion, resistance to scratches and to rubbing actions, a coloration and/or a hydrophobic nature which can be adjusted as desired, good adhesion being observed between the mesostructured layer or layers and the metal substrate.

One embodiment of the invention is that the structure additionally comprises at least one dense layer prepared by the sol-gel route, such as a layer described in French patent application No. 2 899 906.

The term “dense layer” is understood to mean a layer not exhibiting porosity at the micrometric scale visible under a scanning electron microscope (SEM) and more particularly exhibiting a porosity of less than 1 μm, measured according to the BET method.

The dense layer is prepared in particular by the sol-gel route starting from at least one metal alkoxide, metal halide, silicon alkoxide or silicon halide as defined above.

Said additional dense layer preferably comprises nanobuilding blocks (NBB) and a polymer or organic/inorganic hybrid matrix.

The nanobuilding blocks can be in the form of clusters or of nanoparticles, preferably of nanoparticles, with a size ranging from 2 to 100 nm, better still from 2 to 50 nm and even better still from 2 to 20 nm, it being possible for the diameter of these nanoparticles to be measured by X-ray diffraction and small-angle X-ray scattering, transmission microscopy (or TEM) or light scattering.

These nanobuilding blocks are essentially based on at least one metal oxide, for example an aluminum, cerium(III) or (IV), silicon, zirconium, titanium or tin oxide.

A first process for the synthesis of these nanobuilding blocks consists in synthesizing them from metal salts by precipitation. Complexing agents can be introduced into the reaction medium in order to control the size of the nanobuilding blocks formed and to provide for their dispersion in the solvent by functionalization of 80 to 100% of the surface area of the nanoblocks with monodentate or polydentate complexing agents, such as, for example, carboxylic acid, β-diketone, β-ketoester, α- or β-hydroxy acid, phosphonate, polyamine and amino acid. The ratio by weight between the inorganic and organic components is in particular between 20 and 95%.

The nanobuilding blocks can also be obtained from at least one metal alkoxide or metal halide via hydrolytic or nonhydrolytic processes. In the case of a hydrolytic process, the controlled hydrolysis is carried out of at least one metal alkoxide or metal halide precursor of general formula:

M₁(Z₁)ₙ₁ (9),

(R₁′)ₓ₁M₁(Z₁)ₙ₁₋ₓ₁ (10) or

(L₁^{m1})ₓ₁M₁(Z₁)ₙ₁₋ₘ₁ₓ₁ (11),

in which formulae (9), (10) and (11):

M₁ represents Al(III), Ce(III), Ce(IV), Si(IV), Zr(IV), Ti(IV) or Sn(IV), preferably Zr(IV) or Ce(IV), the figure in brackets being the valency of the metal atom,

n₁ represents the valency of the atom M₁,

x₁ is an integer ranging from 1 to n₁-1,

Z₁ represents a halogen atom, such as F, Cl, Br and I, preferably Cl and Br, or —OR₁;

R₁ represents an alkyl group preferably comprising from 1 to 4 carbon atoms, such as a methyl, ethyl, n-propyl, isopropyl or butyl group, preferably methyl or ethyl;

R₁′ represents a nonhydrolyzable group chosen from alkyl groups, in particular C₁₋₄ alkyl groups, for example methyl, ethyl, propyl or butyl; alkenyl groups, in particular C₂₋₄ alkenyl groups, such as vinyl, 1-propenyl, 2-propenyl and butenyl; alkynyl groups, in particular C₂₋₄ alkynyl groups, such as acetylenyl and propargyl; aryl groups, in particular C₆₋₁₀ aryl groups, such as phenyl and naphthyl; methacryloyl or methacryloyloxy(C₁₋₁₀ alkyl) groups, such as methacryloyloxypropyl; and epoxyalkyl or epoxyalkoxyalkyl groups in which the alkyl group is a linear, branched or cyclic C₁₋₁₀ alkyl group and the alkoxy group comprises from 1 to 10 carbon atoms, such as glycidyl and glycidyloxy(C₁₋₁₀ alkyl);

L₁ is a monodentate or polydentate complexing ligand, preferably a polydentate complexing ligand, for example a carboxylic acid, such as acetic acid, a β-diketone, such as acetylacetone, a β-ketoester, such as methyl acetoacetate, an α- or β-hydroxy acid, such as lactic acid, an amino acid, such as alanine, a polyamine, such as diethylenetriamine (or DETA), or a phosphonate, such as phosphonic acid; and

m₁ represents the hydroxylation number of the ligand L₁, with m₁=1 when L₁ is a monodentate ligand and m₁≧2 when L₁ is a polydentate ligand.

The term “controlled hydrolysis” is understood to mean a limitation on the growth of the entities formed by controlling the amount of water introduced into the medium and optionally by introducing a complexing agent for the central metal atom, this being done in order to reduce the reactivity of the precursors.

The nanobuilding blocks, preferably in the form of amorphous or crystalline nanoparticles, can be functionalized at the surface. Their functionalization is carried out either directly during their synthesis or during a second stage following their synthesis, in the presence of a functionalizing agent for NBB, and preferably during a second stage. The terms used are prefunctionalization and postfunctionalization respectively.

The postfunctionalization can be carried out via the chemical route by choosing a difunctional molecule as functionalizing agent for NBB, one of the functional groups of which exhibits an affinity for the surface of the nanobuilding block and the other functional group of which can interact with the matrix but will not exhibit any affinity for the surface of the nanobuilding block. The functionalization via the chemical route thus makes possible a modification of the surface of the nanoblocks, in particular by simple mixing of a solution comprising the nanobuilding blocks with a solution comprising the functionalizing agent for NBB.

Mention may in particular be made, as examples of a functional group exhibiting an affinity for the surface of the nanoblock, of a carboxylic acid functional group, a diketone functional group or a phosphate or phosphonate functional group.

Mention may in particular be made, as examples of a functional group which can interact with the matrix, of primary, secondary or tertiary amine groups, such as C₁₋₈ alkylamino groups, and polymerizable functional groups, such as vinyl, acrylate or methacrylate functional groups.

Mention may in particular be made, as examples of difunctional molecules used as functionalizing agent for NBB, of 6-aminocaproic acid and 2-aminoethyl-phosphonic acid.

Preferably, the degree of functionalization is preferably greater than 50%, better still greater than 80%.

Once the nanobuilding blocks have been synthesized and functionalized, they are introduced into a polymer or inorganic/organic hybrid matrix, preferably a hybrid matrix of sol/gel type, better still based on silica and more preferably still composed of silica or of silica/zirconium oxide. This matrix will act as connector by virtue of which the nanobuilding blocks will form a three-dimensional network.

The inorganic/organic hybrid matrices are obtained in particular by polycondensation of at least two metal alkoxides or metal halides in the presence of a solvent and optionally of a catalyst. The metal alkoxides or metal halides employed are chosen in particular from those having the general formulae:

M₂(Z₂)ₙ₂ (12)

(R₂)ₓ₂M₂(Z₂)ₙ₂₋ₓ₂ (13)

(L₂^{m2})ₓ₂M₂(Z₂)ₙ₂₋ₘ₂ₓ₂ (14)

(Z₂)ₙ₂₋₁M₂-R₃-M₂(Z₂)ₙ₂₋₁ (15)

in which:

n₂ represents the valency of the metal atom M₂, preferably 3, 4 or 5;

x₂ is an integer ranging from 1 to n₂-1;

M₂ represents a metal atom of valency III, such as Al, a metal atom of valency IV, such as Si, Ce, Zr and Ti, or a metal atom of valency V, such as Nb. Preferably, M₂ is silicon (n₂=4), cerium (n₂=4) or zirconium (n₂=4) and more preferably still silicon;

Z₂ represents a hydrolyzable group chosen from halogen atoms, for example F, Cl, Br and I, preferably Cl and Br; alkoxy groups, preferably C₁₋₄ alkoxy groups such as methoxy, ethoxy, n-propoxy, isopropoxy and butoxy; aryloxy groups, in particular C₆₋₁₀ aryloxy groups, such as phenoxy; acyloxy groups, in particular C₁₋₄ acyloxy groups, such as acetoxy and propionyloxy; and

C₁₋₁₀ alkylcarbonyl groups, such as acetyl. Preferably, Z₂ represents an alkoxy group and more particularly an ethoxy or methoxy group;

R₂ represents a nonhydrolyzable monovalent group chosen from alkyl groups, preferably C₁₋₄ alkyl groups, for example methyl, ethyl, propyl and butyl; alkenyl groups, in particular C₂₋₄ alkenyl groups, such as vinyl, 1-propenyl, 2-propenyl and butenyl; alkynyl groups, in particular C₂₋₄ alkynyl groups, such as acetylenyl and propargyl; aryl groups, in particular C₆₋₁₀ aryl groups, such as phenyl and naphthyl; methacryloyl and methacryloyloxy(C₁₋₁₀ alkyl) groups, such as methacryloyloxypropyl; and epoxyalkyl or epoxyalkoxyalkyl groups in which the alkyl group is a linear, branched or cyclic C₁₋₁₀ alkyl group and the alkoxy group comprises from 1 to 10 carbon atoms, such as glycidyl and glycidyloxy(C₁₋₁₀ alkyl). R₂ preferably represents a methyl group or a glycidyloxy(C₁₋₁₀ alkyl) group, such as glycidyloxypropyl;

R₃ represents a divalent nonhydrolyzable group chosen from alkylene groups, preferably C₁₋₄ alkylene groups, for example methylene, ethylene, propylene and butylene; alkenylene groups, in particular C₂₋₄ alkenylene groups, such as vinylene, 1-propenylene, 2-propenylene and butenylene; alkynylene groups, in particular C₂₋₄ alkynylene groups, such as acetylenylene and propargylene; arylene groups, in particular C₆₋₁₀ arylene groups, such as phenylene and naphthylene; methacryloyl and methacryloyloxy(C₁₋₁₀ alkyl) groups, such as methacryloyloxypropyl; and epoxyalkyl or epoxyalkoxyalkyl groups in which the alkyl group is a linear, branched or cyclic C₁₋₁₀ alkyl group and the alkoxy group comprises from 1 to 10 carbon atoms, such as glycidyl and glycidyloxy(C₁₋₁₀ alkyl). R₃ preferably represents a methylene group or a glycidyloxy(C₁₋₁₀ alkyl) group, such as glycidyloxypropyl;

L₂ represents a complexing ligand, such as that described for L₁ above, and

m₂ represents the hydroxylation number of the ligand L₂, with m₂=1 when L₂ is a monodentate ligand and m₂≧2 when L₂ is a polydentate ligand.

The solvent used in the preparation of the matrix is predominantly composed of water. Preferably, it comprises from 80 to 100% by weight of water, with respect to the total weight of the solvent, and optionally a C₁₋₄ alcohol, preferably ethanol or isopropanol.

The catalyst is preferably an acid, better still acetic acid, or CO₂.

At least one additive can optionally be added, either during the preparation of the nanobuilding blocks or during the mixing of the functionalized nanobuilding blocks and the matrix or during both these stages.

In the case when an additive is added during the preparation of the nanobuilding blocks, a final material of core/shell type may be formed, the core being composed of the additive and the shell being composed of a nanobuilding block.

The additives which can be used in the invention are in particular surface-active agents for improving the wettability of the sol over the metal substrate, such as the nonionic fluorinated polymers sold under the trade names FC 4432 and FC 4430 by 3M; dyes, for example rhodamine, fluorescein, methylene blue and ethyl violet; crosslinking agents, such as diethylenetriamine (or DETA); coupling agents, such as aminopropyltriethoxysilane (APTS); nanopigments, and their mixtures.

Said dense layer, preferably comprising nanobuilding blocks and an organic/inorganic hybrid matrix, is obtained in particular, on the one hand:
by preparing the nanobuilding blocks, in particular by a hydrolytic or nonhydrolytic process, as described above, and
by optionally functionalizing them,

on the other hand:
by preparing the matrix,

then:
by mixing the optionally functionalized nanobuilding blocks and the matrix.

It can in addition be deposited according to one of the techniques described above for the deposition of the mesostructured layer.

In the case of the presence of such additional dense layer(s), the mesostructured layer is preferably situated in direct contact with the substrate and thus acts as nanoreservoir for active compounds.

In particular, the structure comprises a multilayer coating comprising at least one mesostructured layer as described above, more particularly at least two layers which comprise at least one mesostructured layer as described above and optionally at least one dense layer as described above, preferably from 2 to 10 and better still from 2 to 5 layers. The total thickness of this multilayer coating preferably varies from 1 to 10 μm.

Another subject matter of the present invention is a process for the preparation of a structure as defined above, comprising the stages consisting in:
(a) preparing a sol-gel material by hydrolysis/condensation of at least one molecular metallic precursor of formula (1), (2), (3) or (4) as defined above, optionally in combination with at least one silicon alkoxide or halide of formula (5), (6), (7) or (8) as defined above, in an aqueous or water/alcohol medium, preferably water/ethanol, in the presence of at least one amphiphilic surfactant and optionally at least one functionalizing agent and optionally in the presence of a latex,
(b) depositing the material obtained in stage (a) on a metal substrate, for example by dip coating, deposition on a rotating substrate (or spin coating), sprinkling, spraying, laminar flow coating or deposition with a brush,
(c) treating the coated substrate thermally or chemically, for example with ammonia vapors, or with UV radiation, or alternatively combining the three treatments, resulting in a densification of the network, and then washing, for example with ethanol, with or without catalyst, such as an acid or base,
(d) optionally removing the surface-active molecules by heat treatment or chemical extraction or by a combination of the two techniques, if necessary, and
(e) optionally carrying out a functionalization stage in order to introduce properties, such as protection from corrosion, resistance to scratches and to rubbing actions, mechanical strength or coloration, but also to improve the compatibility with upper layers.

This optional stage (e) can be carried out, for example, by preparation of a solution comprising the functionalizing agent and then impregnation of the structure obtained in stage (c) or (d) by dipping in said solution for a period of time which can range from a few minutes to a few hours. The functionalizing agent is preferably used in an amount ranging from 1 to 20% by weight, with respect to the total weight of the solution.

In a preferred embodiment of the invention, the sol-gel material is prepared in stage (a) by adding the starting components in the following order:
(1) the molecular metallic precursor or precursors of formula (1), (2), (3) or (4), as defined above,
(2) optionally the silicon alkoxide(s) or halide(s) of formula (5), (6), (7) or (8), as defined above,
(3) the amphiphilic surfactant or surfactants,
(4) the aqueous or water/alcohol medium, preferably water/ethanol, and
(5) optionally the functionalizing agent or agents and optionally a latex.

The amphiphilic surfactant or surfactants are preferably used in an amount ranging from 0.05 to 2 mol % and more particularly from 0.2 to 1 mol %, with respect to the total number of moles of the molecular metallic precursor or precursors.

A further subject matter of the invention is the use of the structure according to the invention for improving the resistance to corrosion, to scratching and to rubbing actions, the mechanical strength, the probe, the coloration and/or the hydrophobic nature of a metal substrate in the aeronautical or aerospace field.

The invention and the advantages which it introduces will be better understood by virtue of the examples given below by way of indication.

### EXAMPLES

### Example 1

Preparation of a Mesostructured Layer Based on SiO₂/ZrO₂+Benzotriazole

A solution of a mixture of precursors was prepared. 0.7 g of ZrCl₄ are added to 55.5 g of ethanol at ambient temperature with stirring. 5.62 g of tetraethoxysilane (TEOS) were subsequently added dropwise.

The triblock copolymer sold under the trade name Pluronic® F127, of formula (EO)₁₀₆(PO)₇₀(EO)₁₀₆, EO denoting ethylene oxide and PO denoting propylene oxide, was used as amphiphilic surfactant. 2 g of this surfactant were added to the preceding solution of precursors so that the ratio s=[surfactant]/([TEOS]+[ZrCl₄]) is 0.005.

Finally, 10.8 g of water were added in order to obtain a degree of hydrolysis h=[H₂O]/([Si]+[Zr])=10. The mixture was stirred at ambient temperature for 1 hour.

A few minutes before the deposition of the film, 60 mg of benzotriazole ([benzotriazole]/([Si]+[Zr]=0.05)) were added as corrosion inhibitor, in order to obtain a composition 1.

Furthermore, a substrate made of Al 2024 T3 alloy which is unplated, with dimensions of 80*40*1.6 mm, was prepared according to a methodology known to a person skilled in the art, such as alkali degreasing, followed by chemical acid pickling, with a formulation compatible with environmental regulations.

A film was deposited on the metal substrate by dip coating said substrate in composition 1, with a rate of withdrawal of 0.28 cm.s⁻¹, under controlled ambient conditions (T=20-22° C., relative humidity (or RH)=20-25%). Immediately after the deposition, the film was stored at ambient temperature (20-22° C.) and at a high degree of humidity (50%) for 12 hours. After aging, the coating was densified at 60° C. for 1 hour and then subjected to 1 mol/l (or M) ammonia vapors in a closed container for 10 minutes.

### Example 2

The mixture of 9.3 g of tetramethoxysilane (TMOS), 37.4 g of 3-glycidoxypropyltrimethoxysilane (GPTMS) and 4.9 g of dimethyldiethoxysilane (DMDES) was added dropwise with stirring at ambient temperature to 65 ml of a 0.05M aqueous acetic acid solution. This solution was kept stirred at ambient temperature for one day.

Furthermore, nanoparticles of cerium oxide (sold under the trade name Rhodigard® W200, pH=8.5) (first type of NBB) were functionalized with 6-aminocapric acid (carboxylate/Ce molar ratio=1) and then added, after 4 hours, to the preceding solution. The combined mixture was stirred for 30 minutes.

A second type of NBB was also added in the form of a mixture composed of a 70% solution of tetrapropoxy-zirconium (TPOZ) in propanol/CH₃COOH/H₂O in a ratio by weight of 11.7 g/6 g/4.5 g, stirred beforehand for 30 minutes. The final solution was stirred at ambient temperature for 30 minutes and then 7.96 g of (3-trimethoxysilylpropyl)diethylenetriamine were added dropwise as crosslinking agent. The solution was left standing at ambient temperature for 15 hours with vigorous and uniform stirring.

Finally, immediately before deposition, a dye, rhodamine B, was added to the solution in an amount such that its concentration in the final solution is approximately 10⁻³M.

This sol-gel solution comprising NBBs was subsequently applied, by dip coating, to the mesostructured layer of example 1 under ambient conditions (T=20-22° C., RH=20-25%). The rate of withdrawal was set at 0.68 cm.s⁻¹. The covering deposited was subsequently densified in an oven at 60° C. for 2 hours.

### Example 3

Preparation of a 1st Mesostructured Layer Based on SiO₂/ZrO₂+Mercaptosuccinic Acid

A solution of a mixture of precursors was first of all prepared. 0.7 g of ZrCl₄ was added to 55.5 g of ethanol with stirring at ambient temperature and then 5.62 g of TEOS were added dropwise.

The triblock copolymer sold under the trade name Pluronic® F127 was used as amphiphilic surfactant. 2 g of this surfactant were added to the preceding solution of precursors so that the ratio s=[surfactant]/([TEOS]+[ZrCl₄]) is 0.005.

Finally, 10.8 g of water were added, in order to obtain a degree of hydrolysis h=[H₂O]/([Si]+[Zr])=10, and then the combined mixture was stirred at ambient temperature for 1 hour before deposition, in order to obtain a composition 2.

A film was deposited on a substrate made of Al 2024 T3 alloy which is unplated, with dimensions of 80*40*1.6 mm, prepared in a similar way to that described in example 1. This deposition was carried out by dip coating said substrate in composition 2, with a rate of withdrawal of 0.28 cm.s⁻¹, under ambient conditions (T=20-22° C., RH=20-25%).

Immediately after deposition, the films were stored at ambient temperature (20-22° C.) and a high degree of humidity (50%) for 12 hours. After aging, the coating was treated thermally at 250° C. for 1 hour in order to remove the surfactant and then treated in a UV/O₃ oven for 15 minutes.

The mesostructured coating was subsequently functionalized by immersing the treated layer in a 0.01M aqueous mercaptosuccinic acid solution with stirring for several hours. After immersion, the layer was rinsed with water and was dried in the air.

Another synthesis of this first mesostructured layer can also be carried out in a single stage (or one pot), namely that the surfactant is retained and the mercaptosuccinic acid is introduced directly into the solution.

Deposition of a 2nd Dense Layer:

The sol-gel solution comprising NBBs described above in example 2 was applied to the above functionalized mesostructured layer by dip coating under ambient conditions (T=20-22° C., RH=20-25%). The rate of withdrawal was set at 0.68 cm.s⁻¹. The covering deposited was subsequently densified in an oven at 60° C. for 2 hours.

### Example 4

Preparation of a 1st Mesostructured Layer Based on ZrO₂/Y₂O₃

A treatment solution was prepared by adding 0.1 mol of a mixture of the two metal chlorides YCl₃ and ZrCl₄ (with [Y]/([Y]+[Zr])=20) to a solution of surfactant Pluronic® F127 ([F127]/([Y]+[Zr])=0.005) in ethanol (4 mol). Water was added to the mixture of precursors so that [H₂O]/([Y]+[Zr])=20, in order to obtain a composition 3.

A film was deposited on an Al 2024 T3 substrate, the surface of which was prepared beforehand as indicated in example 1, by dip coating said substrate in composition 3 with a rate of withdrawal of 0.5 cm.s⁻¹ at a controlled temperature (T=20-23° C.) and under controlled humidity conditions (RH=10%). The film was subsequently exposed briefly (1 min) to a high degree of humidity (>75%).

The film was stored at ambient temperature (20-22° C.) and at a high degree of humidity (>50%) for 12 hours. After aging, the film was densified at 110° C. for 1 hour.

Deposition of a 2nd Dense Layer

1.74 g of 8-hydroxyquinoline were introduced immediately before deposition into the sol-gel solution comprising NBBs described above in example 2. The solution was subsequently applied by dip coating to the mesostructured layer under ambient conditions (T=20-22° C., RH=20-25%). The rate of withdrawal was set at 0.68 cm.s⁻¹. The covering deposited was subsequently densified in an oven at 60° C. for 2 hours.

### Example 5

Preparation of a 1st Mesostructured Layer Based on SiO₂/Al₂O₃+8-Hydroxyquinoline

4.2 g of surfactant Pluronic® P123 were dissolved beforehand with stirring in a mixture comprising 90 g of water, 43.5 g of demineralized water and 110 μl of HCl (37%). 3.09 g of AlCl₃·6H₂O were added and then the combined mixture was left stirring for 10 minutes until the solid had completely dissolved. 10.77 g of TEOS were then added with stirring and the combined mixture was left stirring for an additional 10 minutes. Finally, 0.45 g of 8-hyroxyquinoline was added 10 minutes before deposition, in order to obtain a composition 4.

A film was deposited on a metal substrate, the surface of which was prepared beforehand as indicated in example 1, by dip coating said substrate in composition 4 with a rate of withdrawal of 0.28 cm.s⁻¹ under controlled ambient conditions (T=20-22° C., RH=40%). The film was subsequently stored at a high degree of humidity (>70%) and then the coating was densified at 80° C. for 1 hour.

Deposition of a 2nd Dense Layer

The sol-gel solution comprising NBBs described above in example 2 was applied by dip coating to the functionalized mesostructured layer under ambient conditions (T=20-22° C., RH=20-25%). The rate of withdrawal was set at 0.68 cm.s⁻¹. The covering deposited was subsequently densified in an oven at 60° C. for 2 hours.

In the examples, coatings were obtained in the form of films exhibiting total thicknesses ranging from 500 nm to several μm, more particularly between 1 and 6 μm and preferably between 1 and 5 μm.

These films exhibit good stability of the interfaces, namely between the deposited layer and the metal substrate and between the deposited layer and the paint primary deposited coating, and also good resistance to mechanical strains, such as impact and bending. The resistance to corrosion, with or without paint, is at least comparable to that of chromate coatings, indeed even much better in some cases than those of chromate coatings.

1. A structure comprising:
at least one mesostructured layer prepared by the sol-gel route from at least one molecular metallic precursor of a metal alkoxide or halide type of general formula:
MZₙ (1),
R′ₓMZₙ₋ₓ (2)
L^{m}ₓMZₙ₋ₘₓ (3) or
(RO)ₙ₋₁M-R″-M(OR)ₙ₋₁ (4)
in which formulae (1), (2), (3) and (4):
M represents Al(III), Ce(III), Ce(IV), Zr(IV), Sn(IV), Nb(V), V(V), Ta(V) or Hf(V) or a rare earth metal, the figure in brackets being the valency of the atom M;
n represents the valency of the atom M;
x is an integer ranging from 1 to n-1;
each Z represents, independently of one another, a halogen atom or an —OR group;
R represents an alkyl group comprising from 1 to 4 carbon atoms;
each R′ represents, independently of one another, a nonhydrolyzable group chosen from alkyl groups; alkenyl groups; alkynyl groups; aryl groups; methacryloyl or methacryloyloxy(C₁₋₁₀ alkyl) groups; epoxyalkyl or epoxyalkoxyalkyl groups in which the alkyl group is a linear, branched or cyclic C₁₋₁₀ alkyl group and the alkoxy group comprises from 1 to 10 carbon atoms; C₂₋₁₀ haloalkyl groups; C₂₋₁₀ perhaloalkyl groups; C₂₋₁₀ mercaptoalkyl groups; C₂₋₁₀ aminoalkyl groups; (C₂₋₁₀ aminoalkyl)amino(C₂₋₁₀ alkyl) groups; di(C₂₋₁₀ alkylene)triamino(C₂₋₁₀ alkyl) groups and imidazolyl(C₂₋₁₀ alkyl) groups;
L represents a monodentate or polydentate, complexing ligand,
m represents the hydroxylation number of the ligand L; and
R″ represents a nonhydrolyzable functional group chosen from alkylene groups, N,N-di(C₂₋₁₀ alkylene)amino groups, bis[N,N-di(C₂₋₁₀ alkylene)amino] groups, C₂₋₁₀ mercaptoalkylene groups, (C₂₋₁₀ alkylene)polysulfide groups, alkenylene groups, arylene groups, di(C₂₋₁₀ alkylene)(C₆₋₁₀ arylene) groups and
N,N′-di(C₂₋₁₀ alkylene)ureido groups;
in the presence of at least one amphiphilic surfactant, and
a metal substrate.

2. The structure as claimed in claim 1, wherein M is chosen from Al(III), Ce(III), Ce(IV), Zr(IV), Nb(V), Y(III), La(III) and Eu(III).

3. The structure as claimed in claim 1, wherein the molecular metallic precursor or precursors of general formula (1), (2), (3) or (4) are used in combination with at least one silicon-based precursor of silicon alkoxide, organoalkoxysilane or silicon halide type in the preparation of the mesostructured layer by the sol-gel route.

4. The structure as claimed in claim 3, wherein the silicon-based precursor or precursors correspond to the following formulae:
SiZ₄ (5)
R′ₓSiZ₄₋ₓ (6)
L^{m}ₓSiZ₄₋ₘₓ (7) or
(RO)₃Si—R″—Si(OR)₃ (8)
in which formulae (5), (6), (7) and (8) Z, R′, x, L, m, R and R″ have the same meanings as defined in claim 1.

5. The structure as claimed in claim 1, wherein R is chosen from the methyl, ethyl, n-propyl, isopropyl, n-butyl, s-butyl and t-butyl groups.

6. The structure as claimed in claim 5, wherein R is chosen from the methyl and ethyl groups.

7. The structure as claimed in claim 1, wherein R′ is chosen from the methyl, ethyl, propyl, butyl, vinyl, 1-propenyl, 2-propenyl, butenyl, acetylenyl, propargyl, phenyl, naphthyl, methacryloyl, methacryloyloxypropyl, glycidyl, glycidyloxy(C₁₋₁₀ alkyl), 3-chloropropyl, perfluoropropyl, mercaptopropyl, 3-aminopropyl, 3-[(2-aminoethyl)amino]propyl and 3-[diethylenetriamine]propyl groups.

8. The structure as claimed in claim 1, wherein L represents a carboxylic acid, a β-diketone, a β-ketoester, an α- or β-hydroxy acid, an amino acid, a polyamine, phosphonic acid or a phosphonate.

9. The structure as claimed in claim 1, wherein R″ is chosen from the methylene, ethylene, propylene, butylene, hexylene, octylene, decylene, dodecylene, N,N-diethyleneamino, bis[N-(3-propylene)-N-methyleneamino], mercaptopropylene, propylenedisulfide, propylenetetrasulfide, vinylene, phenylene, di(ethylene)phenylene and N,N′-dipropyleneureido groups.

10. The structure as claimed in claim 1, wherein the amphiphilic surfactant is ionic, amphoteric, zwitterionic or nonionic.

11. The structure as claimed in claim 10, wherein the ionic amphiphilic surfactant is an anionic surfactant.

12. The structure as claimed in claim 11, wherein the anionic amphiphilic surfactant is an anionic amphiphilic molecule chosen from phosphates, sulfates, sulfonates and carboxylic acids.

13. The structure as claimed in claim 10, wherein the ionic amphiphilic surfactant is cationic.

14. The structure as claimed in claim 13, wherein the cationic amphiphilic surfactant is chosen from quaternary ammonium salts and from phosphonium salts.

15. The structure as claimed in claim 14, wherein the quaternary ammonium salts are chosen from those corresponding to the following general formula (I): 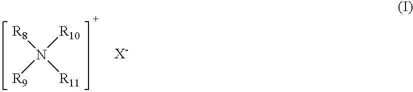
in which the R₈ to R₁₁ radicals, which can be identical or different, represent linear or branched aliphatic groups comprising from 1 to 30 carbon atoms, and X represents a halogen atom or a sulfate.

16. The structure as claimed in claim 15, wherein the quaternary ammonium salts are chosen from dialkyldimethylammonium or alkyltrimethylammonium halides in which the alkyl radical comprises approximately from 12 to 22 carbon atoms.

17. The structure as claimed in claim 10, wherein the nonionic amphiphilic surfactant is chosen from ethoxylated linear C₁₂₋₂₂ alcohols comprising from 2 to 30 ethylene oxide units and esters of fatty acids comprising from 12 to 22 carbon atoms and of sorbitan.

18. The structure as claimed in claim 10, wherein the nonionic amphiphilic surfactant is an amphiphilic block copolymer chosen from:
copolymers based on poly((meth)acrylic acid),
copolymers based on polydiene,
copolymers based on hydrogenated diene,
copolymers based on poly(ethylene oxide),
copolymers based on poly(propylene oxide),
copolymers based on polyisobutylene,
copolymers based on polystyrene,
copolymers based on polysiloxane,
copolymers based on poly(2-vinylnaphthalene),
copolymers based on poly(vinylpyridine and N-methylvinylpyridinium iodide), and
copolymers based on poly(vinylpyrrolidone).

19. The structure as claimed in claim 1, wherein the amphiphilic surfactant or surfactants are used in an amount ranging from 0.05 to 2 mol %, with respect to the total number of moles of the molecular metallic precursor or precursors.

20. The structure as claimed in claim 1, wherein a latex is present during the preparation of the mesostructured layer.

21. The structure as claimed in claim 1, wherein the mesostructured layer is functionalized.

22. The structure as claimed in claim 21, wherein the preparation of the mesostructured layer by the sol-gel route is carried out in the presence of at least one functionalizing agent.

23. The structure as claimed in claim 21, wherein the mesostructured layer is treated with at least one functionalizing agent.

24. The structure as claimed in claim 22, wherein the functionalizing agent is chosen from agents which confer resistance to corrosion, resistance to scratches and rubbing actions or mechanical strength, or which form a fluorescent probe for capturing halogenated compounds or a pH-sensitive probe, or which confer a coloration.

25. The structure as claimed in claim 24, wherein the functionalizing agent is chosen from organic anticorrosion agents of azole, amine, mercaptan, carboxylate and phosphonate types; inorganic anticorrosion agents of nonoxidizing ion types; titanium or aluminum alkoxides and silica or alumina nanoparticles; zirconium oxide; agents composed of an anthracene molecule carrying imidazolium groups; methyl orange and phenolphthalein; and rhodamine, fluorescein, quinizarin, methylene blue and ethyl violet.

26. The structure as claimed in claim 1, wherein the starting components are added in the following order during the preparation of the mesostructured layer:
(1) the molecular metallic precursor or precursors of formula (1), (2), (3) or (4),
(2) optionally the silicon alkoxide(s) or halide(s) of formula (5), (6), (7) or (8),
(3) the amphiphilic surfactant or surfactants,
(4) an aqueous or water/alcohol medium, and
(5) optionally the functionalizing agent or agents and optionally a latex.

27. The structure as claimed in claim 1, wherein the metal substrate is made of titanium, of aluminum or one of their respective alloys, of magnesium alloy or of steel.

28. The structure as claimed in claim 1, wherein it comprises several mesostructured layers, the porosities of which constitute a gradient.

29. The structure as claimed in claim 1, wherein one and the same mesostructured layer exhibits a porosity gradient.

30. The structure as claimed in claim 1, wherein it comprises at least one dense layer comprising nanobuilding blocks and a polymer or organic/inorganic hybrid matrix.

31. The structure as claimed in claim 30, wherein the nanobuilding blocks are based on at least one metal oxide and the organic/inorganic hybrid matrix is obtained by polycondensation of at least two metal alkoxides or halides in the presence of a solvent and optionally a catalyst.

32. A process for the preparation of a structure as claimed in claim 1, wherein it comprises the stages comprising:
(a) preparing a sol-gel material by hydrolysis/condensation of at least one molecular metallic precursor of formula (1), (2), (3) or (4):
MZₙ (1),
R′ₓMZₙ₋ₓ (2)
L^{m}ₓMZₙ₋ₘₓ (3) or
(RO)ₙ₋₁M-R″-M(OR)ₙ₋₁ (4)
optionally in combination with at least one silicon-based precursor of silicon alkoxide, organoalkoxysilane or silicon halide type of formula (5), (6), (7) or (8):
SiZ₄ (5)
R′ₓSiZ₄₋ₓ (6)
L^{m}ₓSiZ₄₋ₘₓ (7) or
(RO)₃Si—R″—Si(OR)₃ (8)
in which formulae (1) to (8) M, Z, R′, L, R, R″, n, x, and m have the same meanings as defined in claim 1, in an aqueous or water/alcohol medium, in the presence of at least one amphiphilic surfactant and optionally of at least one functionalizing agent,
(b) depositing the material obtained in stage (a) on a metal substrate,
(c) treating the coated substrate thermally or chemically or with UV radiation, or alternatively combining the three treatments, resulting in a densification of the network, and then washing,
(d) optionally removing the surface-active molecules by heat treatment or chemical extraction or by a combination of the two techniques, and
(e) optionally carrying out a functionalization stage.

33. The preparation process as claimed in claim 32, wherein the sol-gel material is prepared in stage (a) by adding the starting components in the following order:
(I) the molecular metallic precursor or precursors of formula (1), (2), (3) or (4), as defined above,
(2) optionally the silicon alkoxide(s) or halide(s) of formula (5), (6), (7) or (8), as defined above,
(3) the amphiphilic surfactant or surfactants,
(4) the aqueous or water/alcohol medium, and
(5) optionally the functionalizing agent or agents and optionally a latex.

34. The preparation process as claimed in claim 32, wherein the functionalizing agent is chosen from agents which confer resistance to corrosion, resistance to scratches and rubbing actions or mechanical strength, or which form a fluorescent probe for capturing halogenated compounds or a pH-sensitive probe, or which confer a coloration.

35. The preparation process as claimed in claim 34, wherein the functionalizing agent is chosen from organic anticorrosion agents of azole, amine, mercaptan, carboxylate and phosphonate types; inorganic anticorrosion agents of nonoxidizing ion types; titanium or aluminum alkoxides and silica or alumina nanoparticles; zirconium oxide; agents composed of an anthracene molecule carrying imidazolium groups; methyl orange and phenolphthalein; and rhodamine, fluorescein, quinizarin, methylene blue and ethyl violet.

36. The preparation process as claimed in claim 32, wherein the amphiphilic surfactant is ionic, amphoteric, zwitterionic or nonionic.

37. The preparation process as claimed in claim 36, wherein the ionic amphiphilic surfactant is an anionic surfactant.

38. The preparation process as claimed in claim 37, wherein the anionic surfactant is an anionic amphiphilic molecule chosen from phosphates, sulfates, sulfonates and carboxylic acids.

39. The preparation process as claimed in claim 36, wherein the ionic amphiphilic surfactant is cationic.

40. The preparation process as claimed in claim 39, wherein the cationic amphiphilic surfactant is chosen from quaternary ammonium salts and from phosphonium salts.

41. The preparation process as claimed in claim 40, wherein the quaternary ammonium salts are chosen from those corresponding to the following general formula (I): 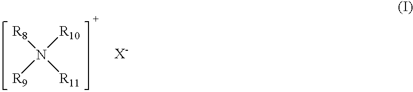
in which the R₈ to R₁₁ radicals, which can be identical or different, represent linear or branched aliphatic groups comprising from 1 to 30 carbon atoms, and X represents a halogen atom or a sulfate.

42. The preparation process as claimed in claim 41, wherein the quaternary ammonium salts are chosen from dialkyldimethylammonium or alkyltrimethylammonium halides in which the alkyl radical comprises approximately from 12 to 22 carbon atoms.

43. The preparation process as claimed in claim 36, wherein the nonionic amphiphilic surfactant is chosen from ethoxylated linear C₁₂₋₂₂ alcohols comprising from 2 to 30 ethylene oxide units and esters of fatty acids comprising from 12 to 22 carbon atoms and of sorbitan.

44. The preparation process as claimed in claim 36, wherein the nonionic amphiphilic surfactant is an amphiphilic block copolymer chosen from:
copolymers based on poly((meth)acrylic acid),
copolymers based on polydiene,
copolymers based on hydrogenated diene,
copolymers based on poly(ethylene oxide),
copolymers based on poly(propylene oxide),
copolymers based on polyisobutylene,
copolymers based on polystyrene,
copolymers based on polysiloxane,
copolymers based on poly(2-vinylnaphthalene),
copolymers based on poly(vinylpyridine and N-methylvinylpyridinium iodide), and
copolymers based on poly(vinylpyrrolidone).

45. The preparation process as claimed claim 32, wherein a latex is present in stage (a).

46. The preparation process as claimed claim 32, wherein the amphiphilic surfactant or surfactants are used in an amount ranging from 0.05 to 2 mol %, with respect to the total number of moles of the molecular metallic precursor or precursors.

47. The preparation process as claimed in claim 32, wherein the metal substrate is made of titanium, of aluminum or one of their respective alloys, of magnesium alloy or of steel.

48. The preparation process as claimed in claim 32, wherein the deposition in stage (b) is carried out by dip coating, deposition on a rotating substrate, sprinkling, spraying, laminar flow coating or deposition with a brush.

49. A product for improving the resistance to corrosion, to scratching scratches and to rubbing actions, the mechanical strength, the probe, the coloration and/or the hydrophobic nature of a metal substrate in the aeronautical or aerospace field comprising the structure as claimed in claim 1.
